(19) United States
(12) Patent Application Publication
(10) Pub. No.: US 2026/0364986 A1
(43) Pub. Date: Nov. 19, 2026

(54) BUMPER ASSEMBLY WITH TOWING EYE

(71) Applicant: BENTELER AUTOMOBILTECHNIK GMBH, Paderborn (DE)

(72) Inventors: Burkhard ROEPER, Paderborn (DE); Elmar MOLLEMEIER, Delbrueck (DE); Ulrich LUETKE-BEXTEN, Paderborn (DE)

(21) Appl. No.: 19/643,804

(22) Filed: Apr. 10, 2026

(30) Foreign Application Priority Data
Apr. 11, 2025 (EP) 25170108.2

(51) Int. Cl. B60D 1/56; B60R 19/02; B60R 19/18; B60R 19/48

(52) U.S. Cl. CPC B60D 1/565; B60R 19/023; B60R 19/18; B60R 19/48; B60R 2019/1813

(57) ABSTRACT

The present disclosure relates to a bumper assembly for a motor vehicle, including a cross member which is coupled to the motor vehicle via crash boxes. The cross member is designed in cross-section as a closed hollow profile, and a sleeve for receiving a towing eye is arranged extending through the cross member. A welded-in sheet metal is arranged in a front wall of the cross member. The sleeve extends through the welded-in sheet metal and the sleeve has a collar on a back side of the cross member and rests against the back side with the collar.

### RELATED APPLICATIONS

The present application claims priority of European Application Number 25170108.2 filed Apr. 11, 2025, the disclosure of which is hereby incorporated by reference herein in its entirety.

### FIELD

The present disclosure relates to a bumper assembly.

### BACKGROUND

Motor vehicles use bumper assemblies. The motor vehicles can be electric vehicles or vehicles equipped with an internal combustion engine. A hybrid vehicle can also be used.

The bumper assembly has a cross member. The cross member extends across the width of the motor vehicle. The cross member has, for example, a curvature around the motor vehicle vertical direction. In most cases, such a bumper is coupled to the motor vehicle, to the longitudinal members of the motor vehicle, via crash boxes.

In the event of a vehicle breakdown, but also, for example, during overseas transport, a towing eye is installed in a motor vehicle. Such a towing eye must be attached to the motor vehicle, as it is stored when not in use, for example in the trunk of the motor vehicle.

It A sleeve-shaped receptacle is provided with a plug-in closure or an internal thread. The towing eye is then inserted into the sleeve with a web-shaped or bolt-shaped extension. Following this, a corresponding force can then be transmitted. For example, the motor vehicle can be towed by transferring a tensile force via the towing eye. The vehicle can also be lashed to a floor by using a suitable lashing device, such as a lashing strap, which is lashed diagonally downwards from the towing eye.

Corresponding sleeves are able to attach to a bumper cross member.

### SUMMARY

The object of the present disclosure is to demonstrate a way to attach such a sleeve to a bumper assembly precisely, suitable for mass production and in a cost-effective manner with improved force transmission.

The bumper assembly is suitable for a motor vehicle. It has a cross member which is coupled to the vehicle via crash boxes.

The cross member itself has a curved or arc-shaped profile. The curvature is formed bent around the motor vehicle vertical direction. The curvature has a changing radius of curvature. In at least one embodiment of the present disclosure, the cross member is less curved in a central region and more curved in the end regions.

Crash boxes are coupled to the cross member itself. The cross member is made of a steel material. The cross member or a profile,, for example, a hat profile of the cross member, can, for example, be made of a hot-formed and press-hardened carbon steel. In at least one embodiment of the present disclosure, it has a tensile strength Rm greater than 1350 MPa.

The cross member itself has a closed hollow profile in its cross-section. In at least one embodiment of the present disclosure, this hollow profile is formed by a hat profile. The opening of the hat profile points towards the motor vehicle longitudinal direction, towards the front. The hat profile is then coupled with a closing sheet metal. The closing sheet metal extends in the motor vehicle transverse direction over a large part of the width or length of the cross member. In at least one embodiment of the present disclosure, the closing sheet metal extends over the entire width or length of the cross member. The closing sheet metal itself can be made of a steel having a tensile strength Rm greater than 500 MPa and less than 1200 MPa, between 500 MPa and 800 MPa. This would have the advantage that the closing sheet metal itself is ductile. The cross member thus has a high inherent stiffness due to the hat profile, but a corresponding extensibility due to the closing sheet metal, so that the cross member would not buckle or break during a pole test.

A sleeve for receiving a towing eye is now arranged extending through the cross member in the motor vehicle longitudinal direction. The sleeve itself is made of a steel material. For example, an internal thread can be formed in the sleeve so that a towing eye with its web-shaped or bolt-shaped extension can be screwed into the sleeve.

According to at least one embodiment of the present disclosure, it is now provided that a welded-in sheet metal is arranged in a front wall of the cross member. The welded-in sheet metal is thus arranged around the region where the sleeve would penetrate the front wall. The front wall of the cross member therefore has a cutout or recess. The welded-in sheet metal is then positioned in this cutout or recess. The welded-in sheet metal itself then has an opening through which the sleeve penetrates the welded-in sheet metal. The welded-in sheet metal thus has a region or receiving region that is itself planar or formed as a plane. This can also be indicated as the receiving plane. A radially circumferential space of 3 mm to 20 mm, 4 mm to 10 mm, is formed around the outer lateral surface of the sleeve, in which this receiving plane is formed in the welded-in sheet metal and is planar in itself, i.e. without bending or curvature.

The sleeve itself still has a collar or stepped shoulder. The sleeve then rests against the back side of the cross member with the collar or stepped shoulder. The sleeve also extends through the back side and thus attaches form-fittingly to the collar on the back side of the cross member. The terms “back side” and “back wall” of the cross member are used synonymously within the scope of at least one embodiment of the present disclosure.

The following advantages are achieved, for example, through the use of the welded-in sheet metal. The welded-in sheet metal is designed as a sheet metal forming component, as a deep-drawn component. The welded-in sheet metal can therefore be easily manufactured by sheet metal forming and thus adapted to the geometric conditions or requirements. In at least one embodiment of the present disclosure, a front wall of the cross member in the region of the sleeve for the towing eye is offset to the back in relation to the motor vehicle longitudinal direction. The sleeve is welded to the welded-in sheet metal, in sections, all the way around. For this to happen, it is necessary that a front end of the sleeve has a protrusion towards the front wall of the cross member or protrudes at a distance. The sleeve retains its strength even after welding to the front wall and that the front side of the sleeve is not deformed by a welding process, a heat-affected zone, or similar. To prevent the sleeve from protruding significantly beyond the front wall of the cross member in the motor vehicle longitudinal direction, the welded-in sheet metal is offset to the back in relation to the motor vehicle longitudinal direction, to a plane of the welded-in sheet metal for receiving the sleeve. This ensures that the front end of the sleeve protrudes on one side relative to the front wall of the cross member, and that the overall protrusion of the sleeve relative to the front wall of the cross member is not significant. This protrusion is 6 mm to 20 mm, 7 mm to 15 mm and 8 mm to 10 mm.

For this purpose, the welded-in sheet metal has a plane, a receiving plane. The receiving plane is oriented parallel to a plane spanned by the transverse and vertical directions of the motor vehicle. However, the receiving plane or plane of the welded-in sheet metal can be arranged at an angle of ±5° relative to the plane spanned by the vehicle vertical direction in the motor vehicle transverse direction.

On the back wall or back side, it is conceivable that the collar runs diagonally relative to a longitudinal axis of the sleeve itself and is thus adapted to the contour or the curved or oblique course of the back wall of the cross member. The sleeve rests form-fittingly against the back wall and can therefore transmit a corresponding tensile force in the motor vehicle longitudinal direction. The collar or sleeve can additionally be thermally joined to the back wall.

In at least one embodiment of the present disclosure, the back wall is embossed in such a way that a receiving plane is also formed in the back wall of the cross member in the region of the sleeve, and this receiving plane runs parallel to the plane spanned by the transverse and vertical directions of the motor vehicle. In this case, the collar is radially circumferential and formed perpendicularly to the longitudinal axis of the sleeve. The collar can therefore also rest form-fittingly, due to the receiving plane, in the back wall.

To ensure that the welded-in sheet metal also provides optimal force transmission in the motor vehicle longitudinal direction, it is attached to the front wall of the cross member from behind, by thermal joining, or by welding. Additionally, the welded-in sheet metal is then welded to the sleeve. Here too, a tensile force is transmitted in the motor vehicle longitudinal direction, and thus optimally supported with regard to the occurring load path.

The cross member is assembled as a hat profile, so that first the sleeve can be inserted and optionally welded to the back wall from the inside, then a closing sheet metal is attached to the hat profile from the front. The closing sheet metal is coupled to the welded-in sheet metal beforehand. After attaching the closing sheet metal and welding the closing sheet metal to the hat profile, the sleeve is then welded through the welded-in sheet metal and also welded to the welded-in sheet metal.

Furthermore, at least one embodiment of the present disclosure, in order to provide a plane or receiving plane on the welded-in sheet metal in the motor vehicle transverse direction, a part of the welded-in sheet metal is bent forwards on the inside. In this sense, “bent forward” means curved in the motor vehicle longitudinal direction. An outer part of the welded-in sheet metal, relative to the motor vehicle transverse direction, is then bent backwards, also relative to the motor vehicle longitudinal direction. This provides a plane that is at least partially offset to the back relative to the front wall of the cross member in the motor vehicle longitudinal direction.

The sleeve itself can be manufactured in a simple way and have an outer diameter that is approximately constant along its length.

The collar can be formed as one piece with the sleeve, but it can also be welded on separately.

In conjunction with a flat receiving plane of the welded-in sheet metal, in which a front opening is formed and penetrated by the sleeve, and a cylindrical sleeve with a constant outer diameter, the welding of the sleeve to the welded-in sheet metal is facilitated.

The opening in the region of the welded-in sheet metal and in the back wall of the cross member is designed as a clearance fit to the sleeve. This allows the sleeve to be inserted into the cross member in a easy-to-assemble manner, and tolerance chain problems due to the multi-step joining sequence can be avoided.

### BRIEF DESCRIPTION OF THE DRAWINGS

Further advantages, features, properties, and aspects of the present disclosure are the subject of the following description. Embodiment variants are shown in the schematic figures. These simplify the understanding of the present disclosure. In particular

FIG. 1 shows a perspective view of bumper assembly according to at least one embodiment of the present disclosure,

FIG. 2 shows a longitudinal section view through the motor vehicle longitudinal direction x and the motor vehicle transverse direction y according to at least one embodiment of the present disclosure,

FIG. 3 shows an alternative design variant according to at least one embodiment of the present disclosure,

FIG. 4 shows an alternative design variant according to at least one embodiment of the present disclosure,

FIG. 5 shows an alternative design variant to FIG. 2 according to at least one embodiment of the present disclosure,

FIG. 6 shows an end region of a cross member according to at least one embodiment of the present disclosure, and

FIG. 7 shows a longitudinal section view through a sleeve with a welded-in sheet metal according to at least one embodiment of the present disclosure.

### DETAILED DESCRIPTION

In the figures, the same reference numerals are used for identical or similar components, even if a repeated representation or enumeration is omitted. The individual design variants can be combined with each other as desired in the context of the present disclosure with individual features, without departing from the scope of this disclosure.

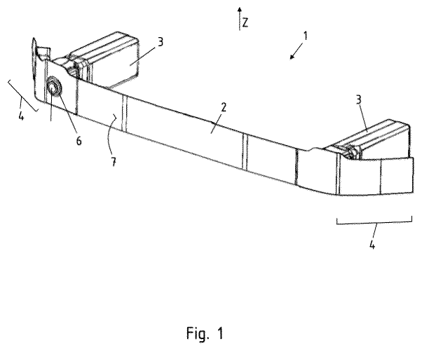

FIG. 1 shows a perspective view of a bumper assembly 1. This assembly has a cross member 2. The cross member 2 is respectively coupled to crash boxes 3. The end regions 4 of the cross member 2 have a stronger curvature around the vehicle vertical direction Z. In the region of the left crash box 3, relative to the image plane, a sleeve 5 is arranged to accommodate a towing eye, not shown in detail. The sleeve 5 radially surrounds a region or receiving region in the front wall of the cross member 2. These have a region or receiving region in which a welded-in sheet metal 6 is arranged in the front wall 7.

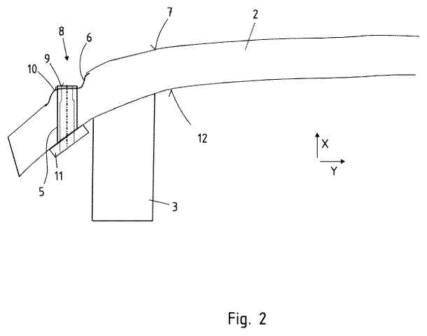

FIG. 2 shows a longitudinal section view through the vehicle longitudinal direction x and transverse direction Y. It can be seen that there is a cutout 8 in the front wall 7 in which the welded-in sheet metal 6 is arranged. The welded-in sheet metal 6 is arranged in relation to the motor vehicle longitudinal direction x, adjacent to the front wall 7 from the back. Thus, the welded-in sheet metal 6 engages behind the front wall 7. If a tensile force in the motor vehicle longitudinal direction X is applied to the sleeve 5 by a towing eye screwed into the sleeve 5 (not shown in detail), this has a beneficial effect on the force flow. The welded-in sheet metal 6 located behind the front wall 7 is not shown in detail and is welded to the front wall 7.

A front end or face 9 of the towing eye thus protrudes beyond the welded-in sheet metal 6. In at least one embodiment of the present disclosure, a plane or receiving plane 10 is formed in the welded-in sheet metal 6. The front side 9 of the eyelet is arranged to protrude towards the motor vehicle longitudinal direction X in relation to this receiving plane 10. A weld seam in the front region of the eyelet with the welded-in sheet metal 6, which is not shown in detail, which is at least partially, or completely circumferential, thus does not reach the front side 9.

At the same time, however, the advantage of the present disclosure is achieved that the front side 9 does not protrude further in the motor vehicle longitudinal direction X beyond the front wall 7, but is, relatively speaking, set back at least in sections with respect to the front wall 7. If the front wall 7 had a curved continuous course here, the front side 9 of the sleeve 5 would extend even further in the motor vehicle longitudinal direction x beyond the front wall 7 in this longitudinal section.

A back side or back wall 12 of the sleeve 5, relative to the motor vehicle longitudinal direction x, is provided with a collar 11. The collar 11 can also be referred to as a stepped shoulder. This is form-fittingly connected to a back side 12 of the cross member 2 and optionally additionally welded, at least in sections, or completely around the circumference. In this case, the collar 11 can be welded to the outer back side from behind relative to the longitudinal direction. A back part of the sleeve 5 can also be welded all the way around to an inner part of the back side 12. In at least one embodiment of the present disclosure, if the cross member 2 is designed as a hat profile, the sleeve can first be inserted and then welded from the inside into the hat profile. Furthermore, it can be seen that the sleeve 5 is arranged externally outside the crash box 3 with respect to the motor vehicle transverse direction Y.

The welded-in sheet metal 6 is bent forwards on one inner side in the motor vehicle transverse direction Y, thus pointing in the motor vehicle longitudinal direction X. An outer part of the sleeve 5, relative to the direction of travel of the motor vehicle, is bent backwards in the motor vehicle longitudinal direction x.

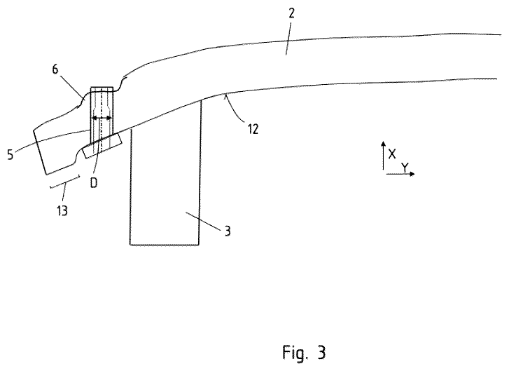

FIG. 3 shows an alternative embodiment variant. A welded-in sheet metal 6 is here also inserted in the region of the sleeve 5. The welded-in sheet metal 6 has an extension in the motor vehicle transverse direction Y which corresponds, for example, to 1.5 times to 5 times, or to 2 times to 3 times, the diameter D of the sleeve 5. Accordingly, the welded-in sheet metal 6 also has an extension in the motor vehicle vertical direction Z, which is not shown in detail and corresponds to 1.5 to 5 times, or 2 to 3 times, the diameter D of the sleeve 5. The back side 12 is offset towards the front with respect to the motor vehicle longitudinal direction X. An outer end section 13 has a greater depth in the motor vehicle longitudinal direction X.

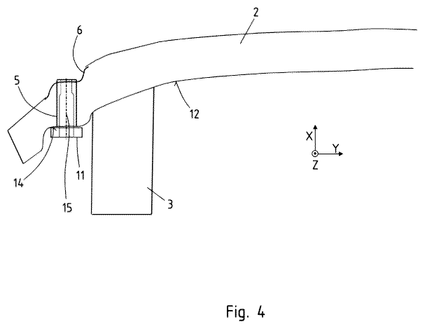

FIG. 4 shows an alternative design variant. Here, a plane 14 or receiving plane is shown on the back side 12 of the cross member 2. This is oriented parallel to a plane spanned by the transverse direction Y and the motor vehicle vertical direction Z. The collar 11 is thus arranged at right angles. Thus, the transmission of a tensile force in the motor vehicle longitudinal direction X, which is not shown in detail, can be optimally initiated. The plane 14 in the back side 12 of the cross member 2 can also be transferred to all other embodiment variants without leaving the scope of the present disclosure.

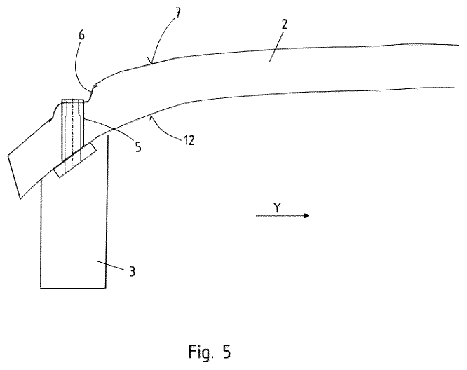

FIG. 5 shows an alternative embodiment to FIG. 2. Here, the position of the sleeve 5 relative to the motor vehicle transverse direction y is shifted such that the sleeve 5 is arranged in the crash box 3. The manufacturing capability here offers the possibility that first the cross member 2 is provided as a hat profile, the sleeve 5 is welded in, then the crash box 3 is coupled to the hat profile, i.e. to the back side 12. Then the front wall 7, for example in the form of a closing sheet metal, can be arranged, which is previously coupled to the welded-in sheet metal 6.

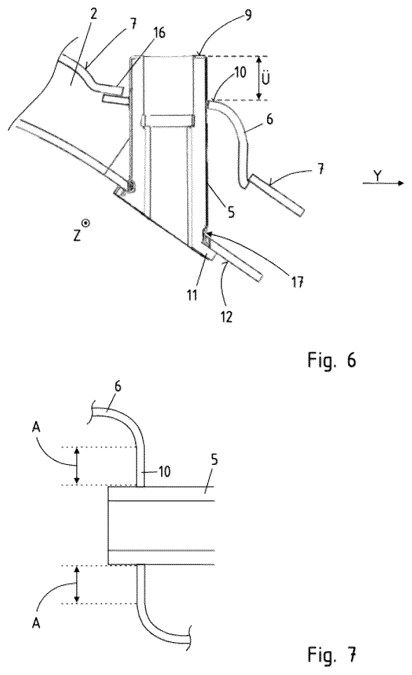

FIG. 6 shows an end region of a cross member 2. The welded-in sheet metal 6 is also arranged here. However, with regard to the motor vehicle transverse direction Y, it is not the welded-in sheet metal 6 that is formed on the inside, but rather the front wall 7 of the cross member 2 that is formed to accommodate the welded-in sheet metal 6. For this purpose, the front wall 7 is first curved more strongly around the motor vehicle vertical direction z and then again oriented with a web 16 in the motor vehicle transverse direction Y. The welded-in sheet metal 6 then engages behind the web 16 as well as a part of the front wall 7 on the outside and is joined to it, not shown in more detail. The collar 11 rests form-fittingly against the back side 12. In the region of the collar 11, the sleeve 5 can have a groove 17 or a constriction. This allows the sleeve 5 to engage form-fittingly into the back wall 12, for example with an interference fit.

As an example, and also for all other embodiment variants as well as the general description, the illustrated protrusion Ü can be designed according to the present disclosure. This means that the front side 9 of the sleeve 5 protrudes beyond the receiving plane 10. This protrusion is 6 mm to 20 mm, 7 mm to 15 mm, and 8 mm to 10 mm.

Furthermore, FIG. 7 shows a longitudinal section through a sleeve 5 with a welded-in sheet metal 6. It can be seen that the receiving plane 10 is designed as a flat or planar surface. This also applies to all design variants as well as the general description. A distance A is formed radially around the outer lateral surface of the sleeve 5. This distance A results in a wide area extent of the receiving plane 10. Thus, a weld seam (not shown in detail) formed between the welded-in sheet metal 6 and the sleeve 5 can be applied as efficiently as possible. This radially surrounding distance A is at least 3 mm and at most 20 mm, between 4 mm and 10 mm. The receiving plane 10 in the welded-in sheet metal 6 can therefore be itself round in a front view. However, the receiving plane 10 can also be angular. However, at least the aforementioned distance A is specified everywhere.

1-13. (canceled)

14. A bumper assembly for a motor vehicle, comprising:
a cross member which is configured to be coupled to the motor vehicle via crash boxes, wherein the cross member has, in cross-section, a closed hollow profile;
a sleeve which is configured to receive a towing eye, and which extends through the cross member; and
a welded-in sheet metal in a front wall of the cross member, wherein
the sleeve extends through the welded-in sheet metal, and
the sleeve has a collar on a back wall of the cross member and rests against the back wall with the collar.

15. The bumper assembly according to claim 14, wherein the cross member has at least one longitudinal section curved about a vertical direction of the motor vehicle, and the sleeve is in the at least one longitudinal section.

16. The bumper assembly according to claim 14, wherein the cross member comprises a hat profile with a closing sheet metal.

17. The bumper assembly according to claim 14, wherein the welded-in sheet metal has a plane which is substantially parallel to a plane which is spanned by a vertical direction and a transverse direction of the motor vehicle.

18. The bumper assembly according to claim 14, wherein the welded-in sheet metal is bent towards a front on an inside and bent towards a back on an outside with respect to a center of the cross member.

19. The bumper assembly according to claim 16, wherein the closing sheet metal is arranged forward of an opening of the hat profile in a longitudinal direction of the motor vehicle, the closing sheet metal comprises the front wall of the cross member, and the welded-in sheet metal is arranged behind the front wall.

20. The bumper assembly according to claim 14, wherein the sleeve has an outer diameter which is constant over a length of the sleeve.

21. The bumper assembly according to claim 14, wherein the sleeve has a front, cylindrical sleeve section having a constant outer diameter, and the collar at a vehicle-side end is larger than the constant outer diameter of the front, cylindrical sleeve section.

22. The bumper assembly according to claim 14, wherein the sleeve is radially welded to the welded-in sheet metal, at least in sections.

23. The bumper assembly according to claim 14, wherein the cross member comprises a hot-formed and press-hardened steel with a tensile strength Rm greater than 1350 MPa.

24. The bumper assembly according to claim 14, wherein an opening of a front receiving plane of the welded-in sheet metal has a clearance fit to the sleeve.

25. The bumper assembly according to claim 14, wherein the welded-in sheet metal has a planar receiving plane oriented parallel to or at an angle of ±5° to a plane spanned by a transverse direction and a vertical direction of the motor vehicle.

26. The bumper assembly according to claim 22, wherein the collar extends obliquely relative to a longitudinal axis of the sleeve on the back wall and is thus adapted to an oblique contour of the back wall of the cross member, wherein the sleeve rests form-fittingly against the back wall and is thermally joined to the back wall.

27. The bumper assembly according to claim 14, wherein an opening of a back receiving plane in the back wall of the cross member has a clearance fit to the sleeve.

28. The bumper assembly according to claim 22, wherein the sleeve is radially welded to the back wall of the cross member, at least in sections.

29. The bumper assembly according to claim 22, wherein the sleeve is radially welded all around to the back wall of the cross member.

30. The bumper assembly according to claim 14, wherein the sleeve is radially welded all around to the welded-in sheet metal.

31. The bumper assembly according to claim 30, wherein the sleeve is radially welded to the back wall of the cross member, at least in sections.

32. The bumper assembly according to claim 30, wherein the sleeve is radially welded all around to the back wall of the cross member.
